(19) United States
(12) Patent Application Publication
(10) Pub. No.: US 2009/0030972 A1
(43) Pub. Date: Jan. 29, 2009

(54) SYSTEM AND METHOD FOR DELIVERING ADVERTISING SIGNAGE REMOTELY

(75) Inventor: Sam Rogers, Minneapolis, MN (US)

Correspondence Address: MERCHANT & GOULD PC, P.O. BOX 2903, MINNEAPOLIS, MN, 55402-0903, US

(73) Assignee: AlivePromo, Inc., Minneapolis, MN (US)

(21) Appl. No.: 12/021,012

(22) Filed: Jan. 28, 2008

Related U.S. Application Data
(63) Continuation of application No. 10/313,894, filed on Dec. 6, 2002.
(60) Provisional application No. 60/339,144, filed on Dec. 7, 2001.

(51) Int. Cl. G06F 15/16

(52) U.S. Cl. 709/203

(57) ABSTRACT

A system for electronically displaying advertising images on remote display devices. The system includes a display content server for scheduling display content upon remote display devices, a plurality of remote display devices in electronic communication with the display content server to receive display content and schedule information from the display content server, each remote display device presents the received display content using the schedule information, and a schedule and content input client for defining the display content and the schedule information for each remote display device. The plurality of remote display devices communicate with the display content server at a periodically repeating interval to obtain additional display content and schedule information from the display content server.

### CROSS-REFERENCE TO RELATED APPLICATIONS

This application is a continuation of and claims priority to U.S. patent application Ser. No. 10/313,894, entitled “SYSTEM AND METHOD FOR DELIVERING ADVERTISING SIGNAGE REMOTELY,” filed Dec. 6, 2002, which claims priority to U.S. Provisional Patent Application Ser. No. 60/339,144, entitled “SYSTEM AND METHOD FOR DELIVERING ADVERTISING SIGNAGE REMOTELY,” filed Dec. 7, 2001. Both of these applications are incorporated herein by reference in their entirety.

### TECHNICAL FIELD

This application relates in general to a method, apparatus, and article of manufacture for providing a distributed processing and image display system, and more particularly to a method, apparatus, and article of manufacture for delivering promotional and advertisement related images to remote display devices.

### BACKGROUND

Digital communications networks, digital image processing, and video display devices are all improving their capabilities to provide information services to a host of potential users. One area of image display usage has not, as of yet, fully taken advantage of these advances in technology. This area of image display usage is advertising signage displays. Advertising signage displays have been constructed using print media that are not readily updated and are expensive to produce. As such, these displays are not typically customized for location, date, and time.

By combining digital communications with electronic displays would permit displays of all types to permit images to be updated at any time. However, the cost of maintaining and utilizing communication networks having a data transfer capacity capable of supporting images, video, and audio data has made such an adoption of digital image displays by advertising signage displays. Such applications of digital image displays for advertising signage may become feasible when the cost associated with transmitting the necessary data is reduced.

### SUMMARY

The present invention relates in general to an apparatus for delivering promotional and advertisement related images to remote display devices. One aspect of the present invention is a system for electronically displaying advertising images on remote display devices. The system includes a display content server for scheduling display content upon remote display devices, a plurality of remote display devices in electronic communication with the display content server to receive display content and schedule information from the display content server, each remote display device presents the received display content using the schedule information, and a schedule and content input client for defining the display content and the schedule information for each remote display device. The plurality of remote display devices communicate with the display content server at a periodically repeating interval to obtain additional display content and schedule information from the display content server.

Another aspect of the present invention is a display content server for defining and transmitting display content and schedule information to a plurality of remote display devices. The display content server has a display device management module for creating the display content and schedule information to be sent to the plurality of remote display devices, a display device video data update module for sending the display content and schedule information to the plurality of remote display devices at the periodically repeating intervals when communications occurs; a modem communications module for providing communications with the plurality of remote display devices using point-to-point communications using a modem; and an Internet interface module for providing communications between the display content server and schedule and a content input client.

### BRIEF DESCRIPTION OF THE DRAWINGS

FIG. 1 illustrates an exemplary distributed processing system according to one possible embodiment in which the invention operates.

FIG. 2a illustrates a computing system that may be used to construct various computing systems that may be part of a distributed processing and communications system according to one embodiment of the present invention.

FIG. 2b shows a set of processing modules used by a display computing system that may be used to construct various computing systems that may be part of a distributed processing and communications system according to one embodiment of the present invention.

FIG. 3a-b shows a set of processing modules used by a server computing system that may be used to construct various computing systems that may be part of a distributed processing and communications system according to one embodiment of the present invention.

FIG. 4a illustrates a web based login screen for an end user accessing a web server according to an embodiment of the present invention.

FIG. 4b illustrates a web server home page for an end user accessing a web server according to an embodiment of the present invention.

FIG. 5a illustrates a management hub module web page according to a second embodiment of the present invention.

FIG. 5b illustrates another management hub module web page for a particular display device according to one embodiment of the present invention.

FIG. 5c illustrates a management hub module web page displaying a plurality of display devices according to another embodiment of the present invention.

FIG. 5d illustrates yet another management hub module web page for a particular display device according to yet another embodiment of the present invention.

FIG. 5e illustrates another management hub module web page for a particular display device according to an example embodiment of the present invention.

FIG. 6a illustrates a scheduling module web page for a particular display device according to an example embodiment of the present invention.

FIG. 6b illustrates another scheduling module web page for a particular display device according to an example embodiment of the present invention.

FIG. 6c illustrates yet another scheduling module web page for a particular display device according to an example embodiment of the present invention.

FIG. 7a illustrates an asset upload module web page according to an example embodiment of the present invention.

FIG. 7b illustrates another asset upload module web page according to an example embodiment of the present invention.

FIG. 8a illustrates an asset upload status info web page according to an example embodiment of the present invention.

FIG. 8b illustrates another asset upload status info web page according to an example embodiment of the present invention.

### DETAILED DESCRIPTION

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The term “connected” means a direct connection between the items connected, without any intermediate devices. The term “coupled” means either a direct connection between the items connected, or an indirect connection through one or more passive or active intermediary devices. The term “circuit” means either a single component or a multiplicity of components, either active and/or passive, that are coupled together to provide a desired function. The term “signal” means at least one current, voltage, or data signal. Referring to the drawings, like numbers indicate like parts throughout the views.

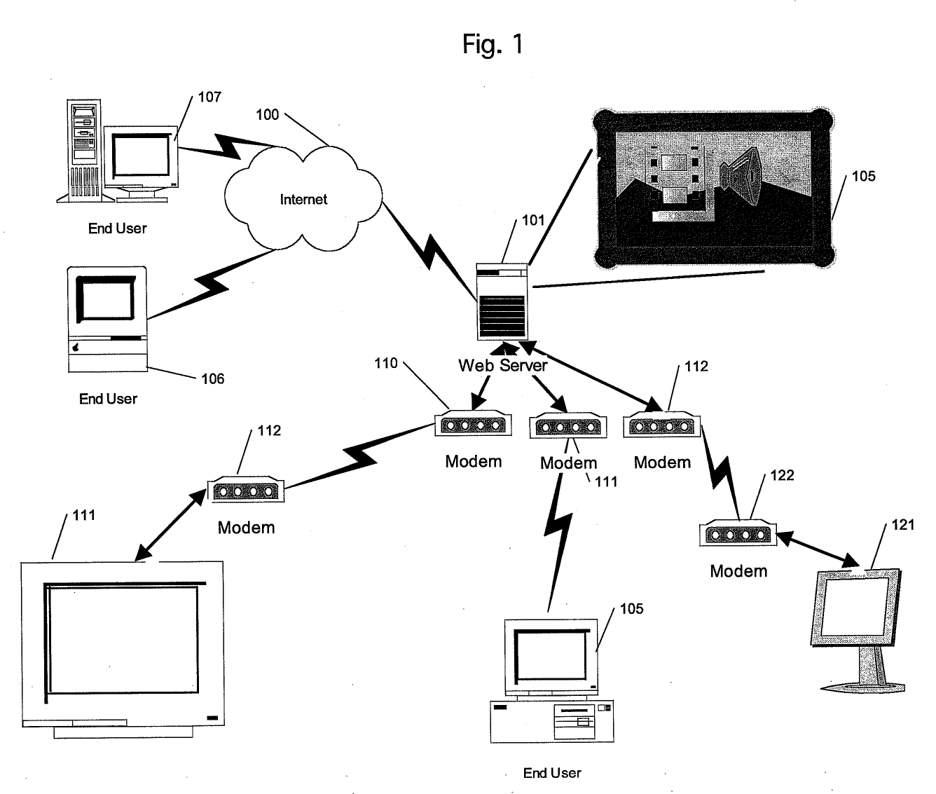

FIG. 1 illustrates an exemplary distributed processing system according to one possible embodiment in which the invention operates. A web server 101 is utilized to store display images 105 that may be used as advertising signage image displays. These display images 105 are ultimately transmitted to end user display devices for use in providing advertising signage images. These end users may be personal computers 105-107, as well as stand-alone display devices 111, 121. In addition, these display devices 111, 121 and personal computers 105-107, may present these images 105 as static snapshot images, a sequence or slide show of static images, and a sequence of video images that may repeat after a pre-determined sequence of images. In all of these cases, the images may be accompanied by a corresponding audio track of data that is synchronously output along with the images.

The web server 101 may communicate with these display devices 111, 121 and the personal computers 105-107, either over the Internet 100 or over a telephone connection that utilizes a pair of modems. 111-113. The display devices 111, 121 periodically communicate with the web server 101, such as once a day, to receive an updated display data set that is to be used until the next time the device 111, 121 communicates with the web server 101. If the display device 111, 121 is unable to communicate with the server 101, the device 111, 121 may continue to display the previously received data set until an update is received. Alternatively, the display device 111,121 may possess a default display data set that may be displayed if a update is not received.

The personal computers 105-107 provide end users with access to the web server 101 to permit the contents of the display data packages 105 to be edited, updated, and scheduled. The end users may control a plurality of display devices 111, 121 and may wish a first data package to be displayed on a first group of display devices. The end user may also wish to display a customized data package on one or more additional display devices 111, 121. This mechanism permits any number of combinations of display sets that allows each display device 111, 121 to present any desired advertising signage image. The end user may specify that the advertising signage image be updated as frequently as needed, within the limits of the communications networks that connect the display devices 111, 121 to the web server 101.

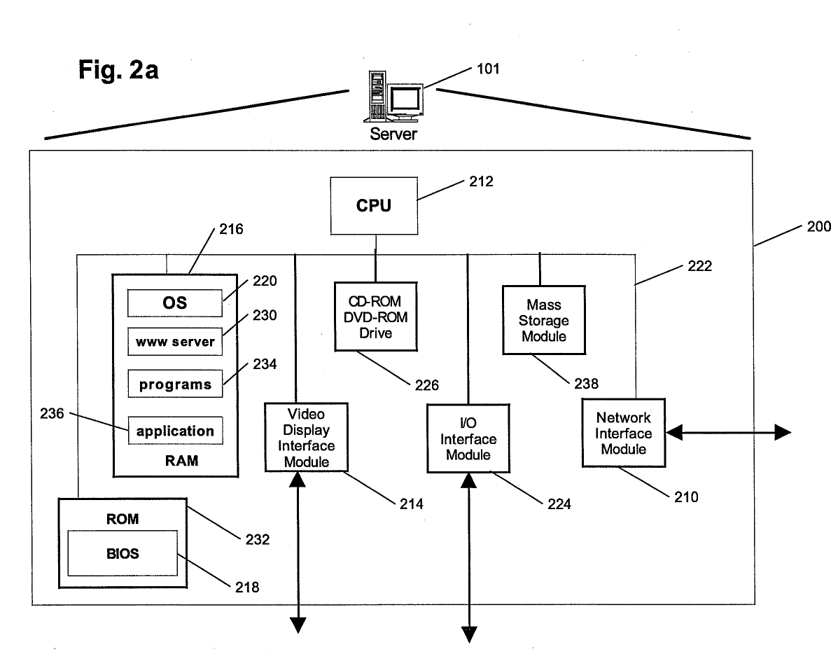

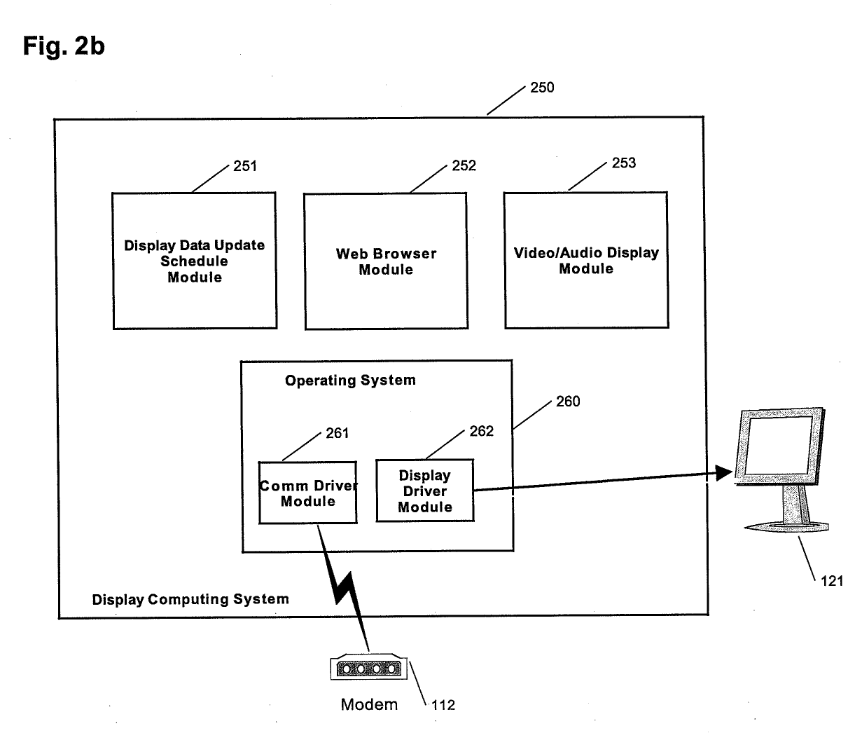

FIG. 2a illustrates a computing system that may be used to construct various computing systems that may be part of a distributed processing and communications system according to one embodiment of the present invention. In an exemplary embodiment of a WWW server 101, computing system 200 is operative to provide a WWW site. Accordingly, WWW server 101 transmits WWW pages to the WWW browser application program executing on requesting devices to carry out this process. For instance, WWW server 101 may transmit pages and forms for receiving information about a user, such as user preferences, address, telephone number, billing information, credit card numbers, and the like. Moreover, WWW server 101 may transmit WWW pages to a requesting device that allow a user to participate in a WWW site. The transactions may take place over the Internet, WAN/LAN 100, or some other communications network known to those skilled in the art.

Those of ordinary skill in the art will appreciate that the WWW server 101 may include many more components than those shown with reference to a computing system 200 shown in FIG. 2. However, the components shown are sufficient to disclose an illustrative embodiment for practicing the present invention. As shown in FIG. 2, WWW server 101 is connected to WAN/LAN 100, or other communications network, via network interface unit 210. Those of ordinary skill in the art will appreciate that network interface unit 210 includes the necessary circuitry for connecting WWW server 101 to WAN/LAN 100, and is constructed for use with various communication protocols including the TCP/IP protocol. Typically, network interface unit 210 is a card contained within WWW server 101.

WWW server 101 also includes processing unit 212, video display adapter 214, and a mass memory, all connected via bus 222. The mass memory generally includes RAM 216, ROM 232, and one or more permanent mass storage devices, such as hard disk drive 228, a tape drive, CD-ROM/DVD-ROM drive 226, and/or a floppy disk drive. The mass memory stores operating system 220 for controlling the operation of WWW server 101. It will be appreciated that this component may comprise a general purpose server operating system as is known to those of ordinary skill in the art, such as UNIX, MAC OS™, LINUX, or Microsoft WINDOWS NT®. Basic input/output system (“BIOS”) 218 is also provided for controlling the low-level operation of WWW server 101.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a WWW site. More specifically, the mass memory stores applications including WWW server application program 230, programs 234, and a real-time song popularity application 236. WWW server application program 230 includes computer executable instructions which, when executed by computer 200, generate WWW browser displays, including performing the logic described above. WWW server 101 may include a JAVA virtual machine, an SMTP handler application for transmitting and receiving email, an HTTP handler application for receiving and handing HTTP requests, JAVA applets for transmission to a WWW browser executing on a client computer, and an HTTPS handler application for handling secure connections. The HTTPS handler application may be used for communication with external security applications (not shown), to send and receive private information in a secure fashion.

WWW server 101 also comprises input/output interface 224 for communicating with external devices, such as a mouse, keyboard, scanner, or other input devices not shown in FIG. 2. Likewise, WWW server 101 may further comprise additional mass storage facilities such as CD-ROM/DVD-ROM drive 226 and hard disk drive 228. Hard disk drive 228 is utilized by WWW server 200 to store, among other things, application programs, databases, and program data used by WWW server application program 230. For example, customer databases, product databases, image databases, and relational databases may be stored. The operation and implementation of these databases is well known to those skilled in the art.

A display computing system 111, 121, as illustrated in additional detail in reference to FIG. 2b below, comprises a general purpose computing system illustrated within FIG. 2a as discussed above. However, one skilled in the art will recognize that such a display computing system may operate with a subset of the above components to perform the functions associated with displaying promotional and advertisement data without deviating from the spirit and scope of the present invention.

FIG. 2b shows a set of processing modules used by a display computing system that may be used to construct various computing systems that may be part of a distributed processing and communications system according to one embodiment of the present invention. The display devices 111, 121 consist of a display device 241 and a display computing system 250 to provide the data communication, data storage, and data display functions needed to provide the advertising signage display functions. The display computing system 250 communicates with the web server 101 using a connected modem 112 to receive the display data sets. The display computing system 250 outputs the display images 105 onto a display device 241 such as a video monitor, liquid crystal display, plasma display, and television device.

The display computing system 250 comprises a set of processing modules to implement functions needed to support the display system. These modules include a Display Data Update Schedule module 251, a Web Browser module 252, a Video/Audio Display module 253, and a plurality of operating system modules 260. The operating system modules 260 include low-level device drivers such as a communications driver 261 for providing communications between the display computing system 250 and external devices and a display driver module 262 for outputting image and audio data to a display device 241. These operating system modules may be part of any operating system such as WINDOWS from MICROSOFT, MAC OS from APPLE COMPUTER, UNIX, and LINUX.

The Display Data Update Schedule module 251 periodically establishes communications with a web server to obtain update information regarding the data to be displayed. The display computing system 250 periodically, such as once a day at a pre-determined time of the day, will establish communications with a web server to download the multi-media data that is to be shown on the display device 121. In a preferred embodiment, this communications is established as a point-to-point connection using a modem 112 that makes a telephone call to the server. As such, a time slot during the day is allocated for each display computing system to make this call. Of course, any number of time slots may be allocated to any given display computing system 250 if additional updates are needed during any particular period of time. This update scheduling mechanism may also be different for each display computing system depending upon its location and the needs to change the frequency in which the display data is changed. Finally, the update scheduling mechanism may also dynamically change the update frequency for each individual display computing system if desired.

One skilled in the art will also recognize that the communications between the display computing system 250 and the web server may occur over other communications network. For example, display computing systems may communicate with the web server over the Internet during its pre-determined time slot rather than using a point-to-point telephone call. In the preferred embodiment, the modem 112 is used to place a better control upon the use of a fixed time slot for each display computing system 250 as a means to effectively control the instantaneous communications bandwidth needed for the server. However, as the communications capacity of servers and networks increase, this limitation of the system may not be as significant an issue.

The Web Browser module 252 processes the multi-media display data to generate the signage information displayed upon a display device 121. In one embodiment, the multi-media data is specified using a web-based multi-media content creation tool such as FLASH 5 from MACROMEDIA INC. These tools accept digital representations of video and audio data that can be processed into a compact data format for transmission over a communications network for display by a display computing system 250. The web browser module 252 in such an embodiment may be a web browser such as NETSCAPE NAVIGATOR or MICROSOFT INTERNET EXPLORER that utilizes a plug-in module compatible with the content creation tool. In the case of FLASH 5, a FLASH MEDIA PLAYER module exists to display this multi-media content upon a display device 121.

The Video/Audio Display module 253 processes the low level multi-media data to generate the electronic signals needed for communications between the display computing system 250 and the display device 121. These modules may be part of an computing system's operating system or may be part of a multi-media processing package needed to satisfy any individual needs of a particular display technology. As the resolution of a display device changes, a set of processing modules may be needed to make the data compatible with the particular needs of a display device.

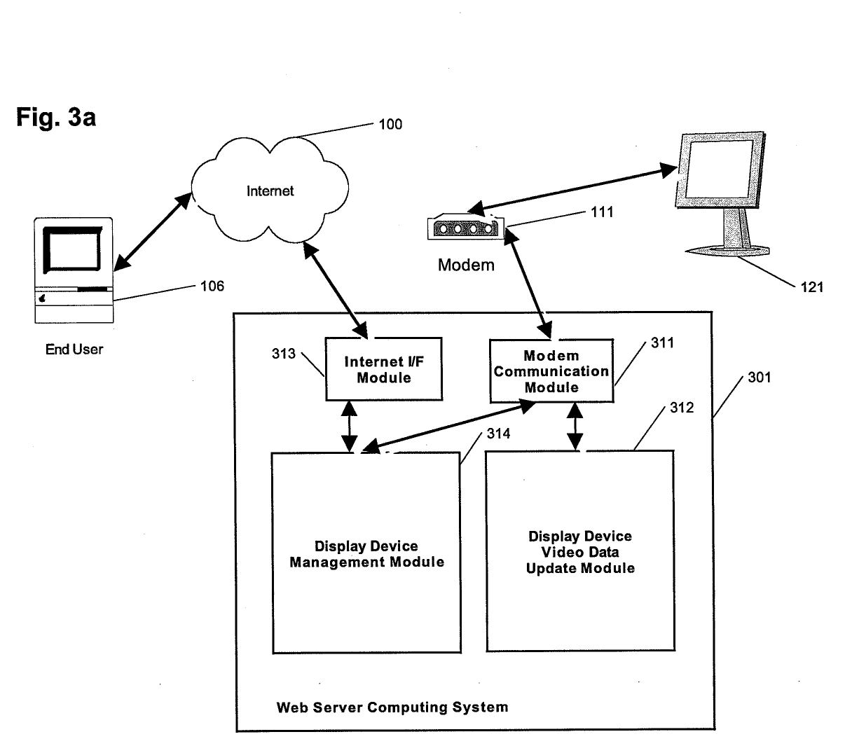

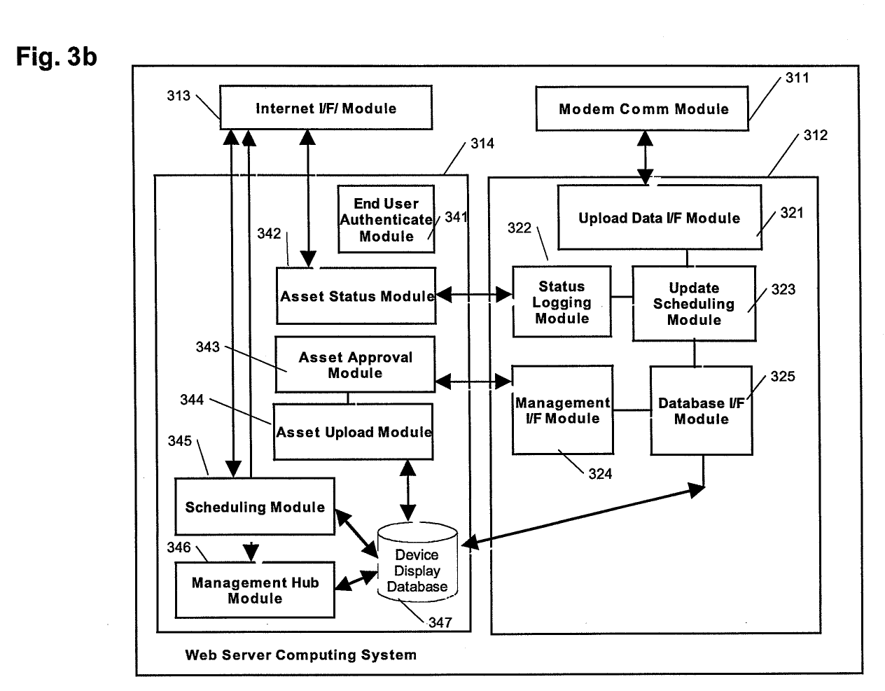

FIG. 3a illustrates a set of processing modules used by a server computing system that may be used to construct various computing systems that may be part of a distributed processing and communications system according to one embodiment of the present invention. The server computing system 301 provides two separate and distinct sets of processing functions. First, the server computing system 301 communicates with the individual display computing systems 250 on a periodic basis to provide the updates the data to be displayed. The server computing system 301 maintains an update schedule for each display computing system 250 and provides the needed update data during the display computing system's 250 time slot to call the server for the data. This processing is performed by a display device video data update module 312. The display device video data update module 312 also maintains a log of the data transmitted to each display computing system 250.

The server computing system 301 contains a display device management module 314 to provide end users 106 a mechanism to create, modify and delete an update schedule for each display computing system 250. This module 314 provides the end user 106 to modify a database of information describing the multi-media data that is to be displayed upon each display computing system 250 at various times during each day. Both the display device video data update module 312 and the display device management module 314 communicate with external computing systems through interface modules. An Internet interface module 313 allows processing modules within the web server computing system 301 to communicate with client computers over the Internet 100. Similarly, a modem communications module 311 allows the web server computing system 301 to make and receive calls using a modem to establish a communications link with an external computer. One skilled in the art will recognize that other modules may be used to establish similar communications paths between the web server computing system 301 and other computers without deviating from the spirit and scope of the present invention.

FIG. 3b illustrates a set of processing modules used by a server computing system that may be used to construct various computing systems that may be part of a distributed processing and communications system according to another embodiment of the present invention. As discussed above, the server computing system 301 includes a display device video data update module 312, the display device management module 314, an Internet interface module 313, and a modem communications module 311. The display device video data update module 312 maintains an update schedule for each display computing system 250 and provides the needed update data during the display computing system's 250 time slot to call the server for the data and comprises an update data interface module 321, a status logging module 322, an update scheduling module 323, a management interface module 324, and a database interface module 325.

The update data interface module 321 provides a common data communications mechanism between the lower level modem communications module 311 and all other processing modules within the display device video data update module 312. This module permits the status logging functions and the data update functions within the display device video data update module 312 to communicate with display computing systems 250 using a common interface.

The status logging module 322 obtains and maintains a log of information relating to the status of each display computing system 250 that is scheduled to communicate with the server computing system 301. This status information may include simply whether the display computing system 250 contacted the server computing system 301 to obtain an update to its display data. Additionally, this status information may include whether a data update was successfully transmitted to the display computing system 250. Finally, the status information may also include error messages generated by the display computing system 250 to communicate errors detected by the display computing system 250 at its remote location. These error messages may be used to schedule a maintenance and repair visit by an appropriate support technician as needed.

The update scheduling module 323 communicates with display computing systems 250 to provide these systems with the display data needed for the time period between a current contact by a particular display computing system and its corresponding next scheduled communications time slot. In one embodiment in which a display computing system 250 contacts the server computing system once a day, this module 323 is responsible for providing the display computing system with all display data needed for use during the next day. This data would include any multi-media data to be output as well as any scheduling information if the display data is desired to change throughout the day. If the display data and/or the scheduling information is not changed from one day to the next, the module 323 may not need to actually transmit any information.

The management interface module 324 provides an interface between the display device video data update module 312 and the display device management module 314 to permit user specified display data packages and scheduling information to be stored for use when providing data updates to display computing systems 250. The database interface module 325 provides a single data access module for processing modules to store and retrieve data from the device display data database 326.

The display device management module 314 provides end users 106 a mechanism to create, modify and delete an update schedule for each display computing system 250. The display device management module 314 comprises an end user authenticate module 341, an asset status module 342, an asset approval module 343, an asset upload module 344, a scheduling module 345, a management hub module 346, and a device display data database 347.

The end user authenticate module 341 determines if an end user 106 is permitted to access and to modify one or more parts of the display data and scheduling information associated with one or more display computing system 250. End users 106 access the server computing system using a web browser, such as NETSCAPE NAVIGATOR or MICROSOFT INTERNET EXPLORER, to make these changes. The identity of users attempting to make modifications needs to be authenticated as well as determine whether a particular user is authorized to make the current modification. In one embodiment, the end user 106 would enter an ID and a password. This module 341 would determine if the end user 106 is known as well as whether the user may access the corresponding web page. This information is maintained for use throughout the session in which the user assesses the server computing system. In one embodiment, the server system is implemented using COLD FUSION server software from MACROMEDIA, INC. of San Francisco, Calif.

The asset status module 342 provides end users with access to the identity and status of the display data and scheduling information to be displayed on one or more display computing systems. A set of display data and its scheduling information is assigned to a particular display device, which is referred to as an asset. The status of a particular set of display data and its scheduling information as well as the status of the display computing system is useful to end users. This module 342 provides access to this information.

The asset approval module 343 determines whether a particular set of display data and its scheduling information may be included within the data to be sent to a display computing system 250 by the display device video data update module 312. Because a particular end user responsible for creating and loading a particular set of display data and its scheduling information onto the server computing system 301 may not be the end user responsible for permitting the set of display data to be send to display computing systems, this module permits the sets of data to be set up for use by the display device video data update module 312. However, a second end user with a different level of authority is needed to authorize the use of this particular set of display data and its scheduling information. As such, errors in the display of information on display devices should be reduced.

The asset upload module 344 transfers the particular set of display data and its scheduling information from the server computing system 301 to the display computing systems 250 as directed by the update scheduling module 323 when the display computing systems 250 contacts the server computing system 301. The module 344 determines, using the asset approval module 343, whether a particular set of display data and its scheduling information is approved for upload.

The scheduling module 345 provides an end user with access to scheduling data for each display computing system 250. The end user may display, create, modify, delete and save a schedule using this module. These schedules are used when a set of data is to be uploaded to a display computing system 250 as well as determine if multiple data sets are sent for use between contact between the display computing system 250 and the server computing system 301. If the data to be displayed is to change one or more times throughout a day, the schedule will include all information to determine when it is to change during a day as well as what is to be displayed during each period of time during the day.

The management hub module 346 provides end users 106 with access to information regarding the identity and location of all display computing systems 250 that are scheduled to contact the server computing system 301. The module 346 allows end users to retrieve, view, modify, create, and delete this information. This information is needed to determine what sets of display data and scheduling information are to be uploaded to a particular device. The device display data database 347 contains all of the sets of display data and scheduling information that are used throughout the server computing system.

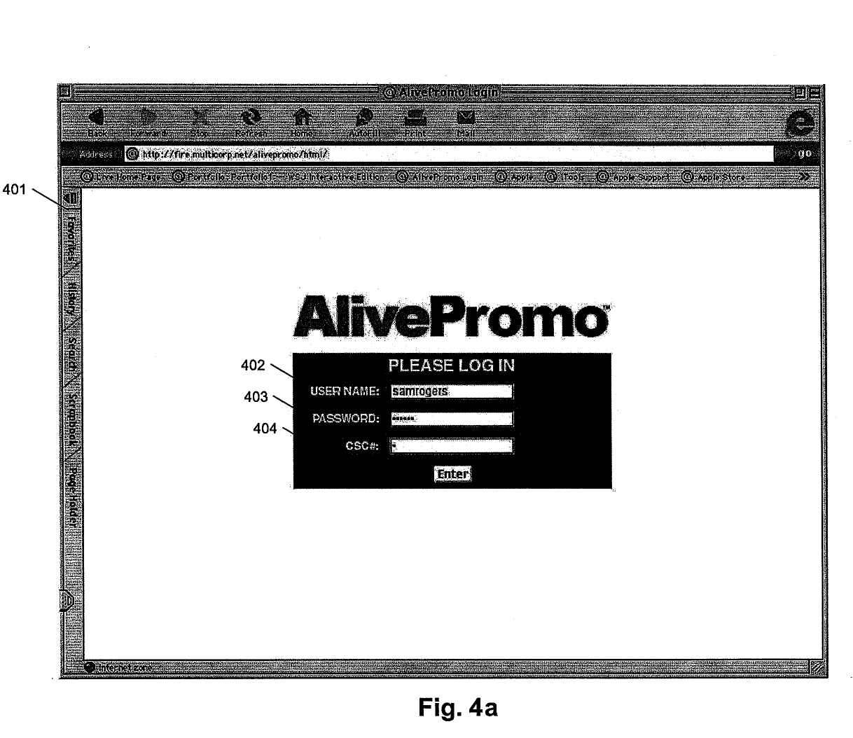

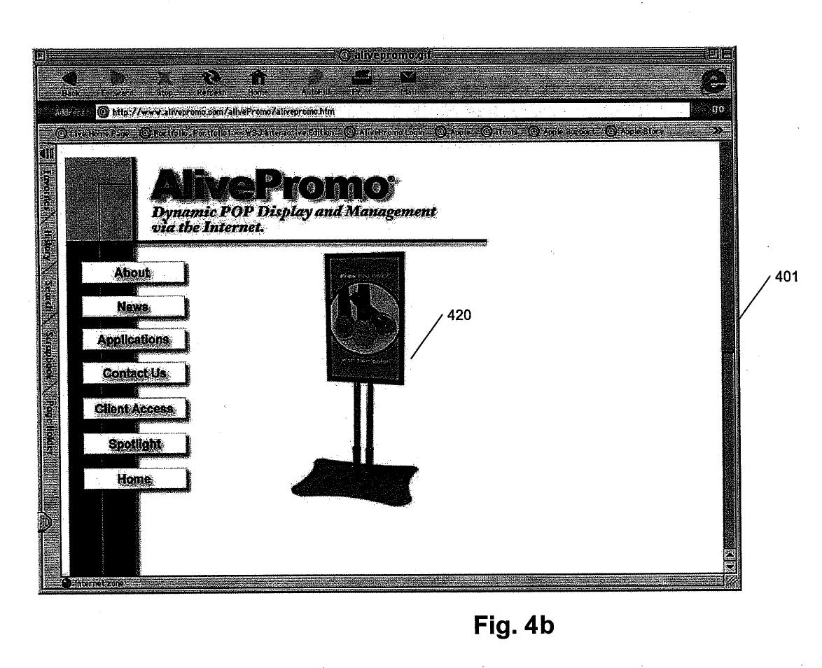

FIGS. 4a and 4b illustrate a typical web browser-based interface seen by an end user when accessing the server computing system. FIG. 4a illustrates a web based login screen for an end user accessing a web server according to an embodiment of the present invention. The end user provides the necessary information to permit the end user authenticate module 341 to determine if the end user may perform one or more functions. As shown here, the end user provides a user ID 402, a password 403, and a CSC code 404. Of course, other authentication and authorization schemes may be used without deviating from the spirit and scope of the present invention. In addition, this communications may require secure transmission of any data if needed.

FIG. 4b illustrates a web server home page for an end user accessing a web server according to an embodiment of the present invention. Once an end user has been authenticated, a web page 401 is presented that allows access to all other server computing system functions. This web page 401 illustrates one embodiment for the display device that includes a large plasma display 420. The display computing system 250 is contained within an enclosure on the rear side of the display in this embodiment.

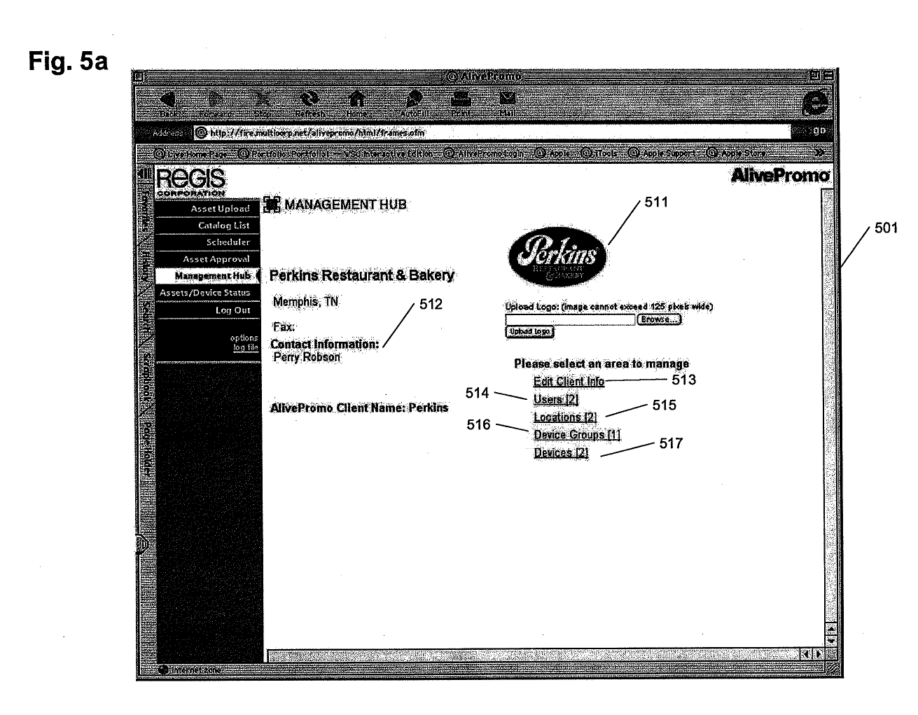

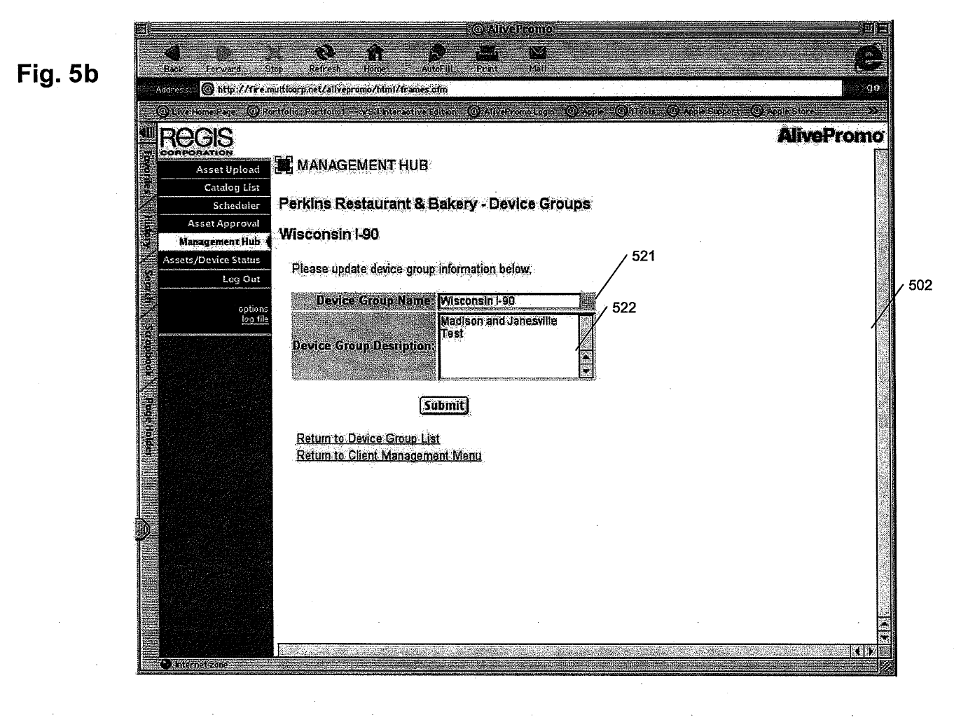

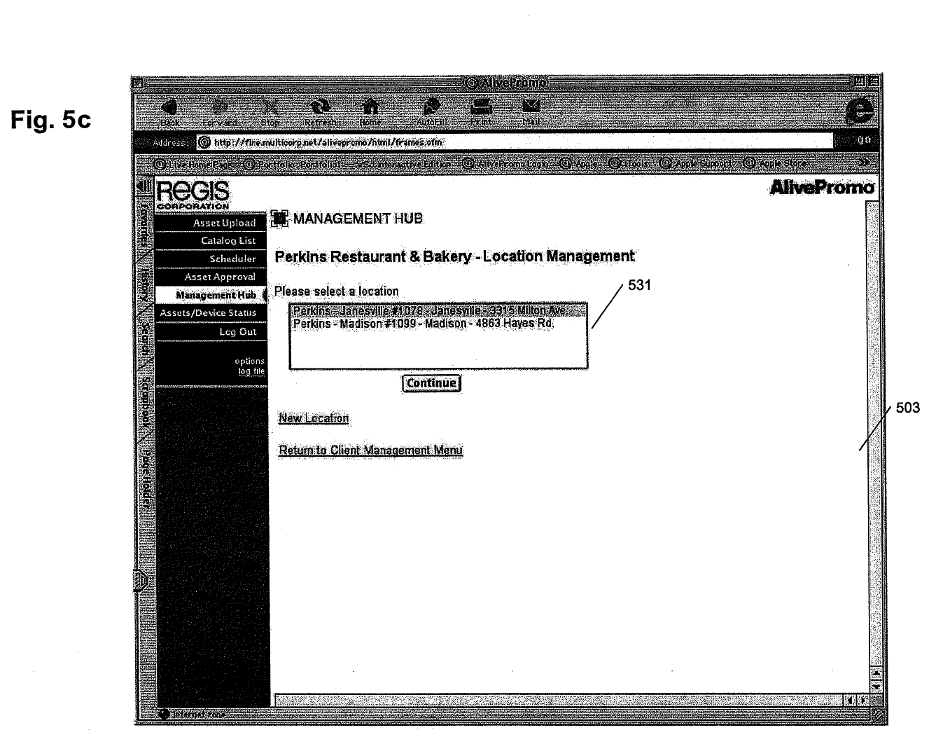

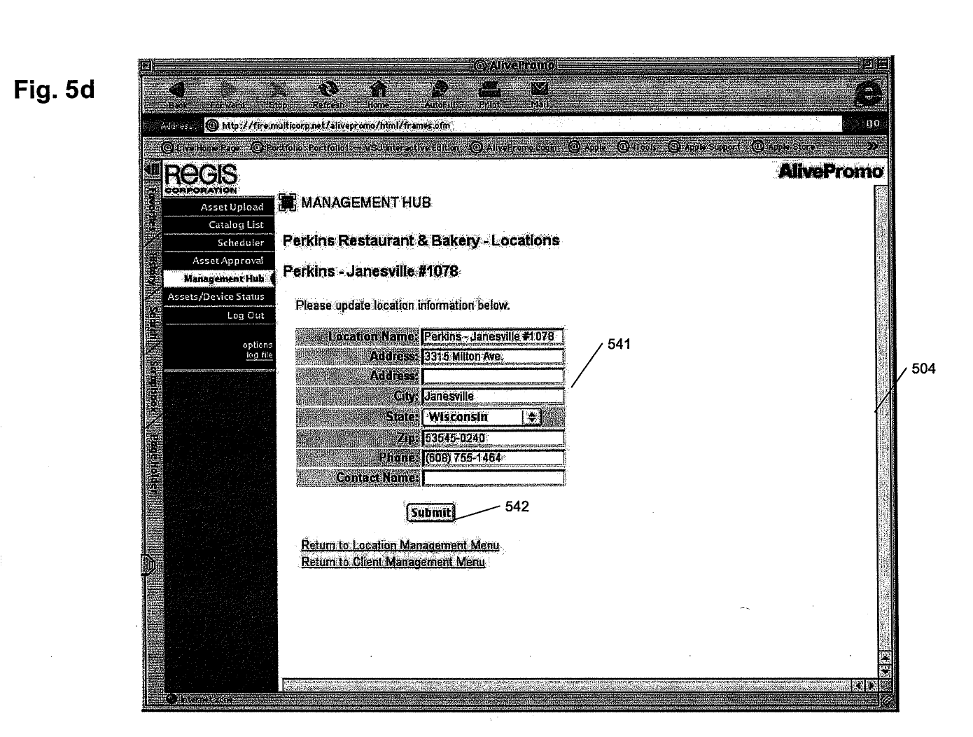

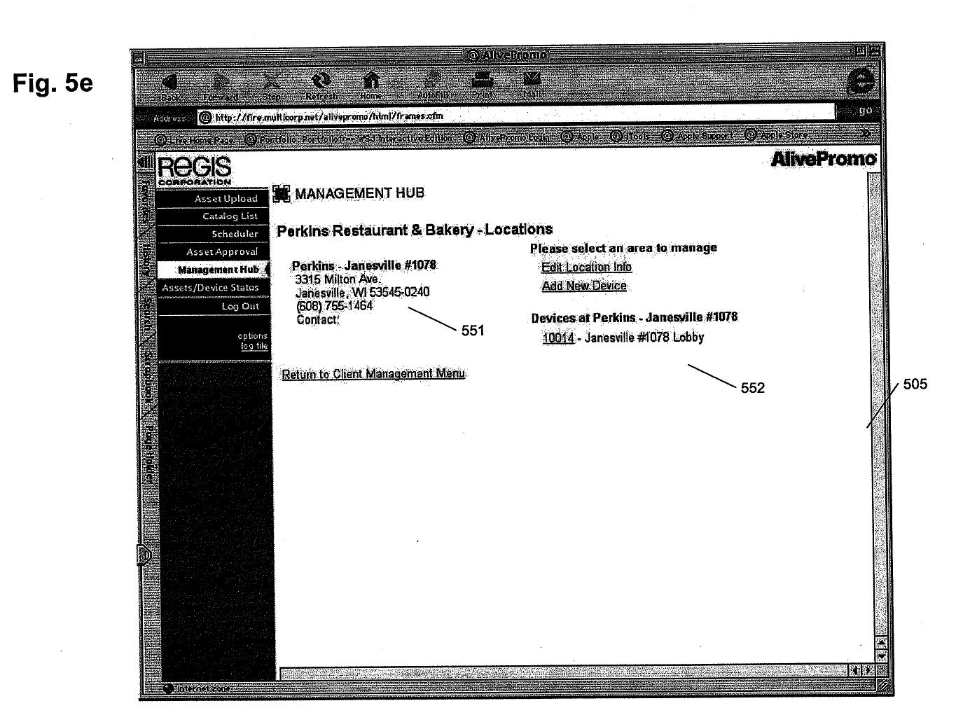

FIGS. 5a-5e illustrate a set of web pages used by the management hub module 346. FIG. 5a illustrates a management hub module web page according to a second embodiment of the present invention. This web page 501 provides access to all asset and scheduling information for a particular client using display computing systems 250. If multiple clients exist, a similar page would exist for each client and the web page may display a logo 511 for each client. The web page 501 may also display client information 512 to identify contact info for the particular client. The page may also possess links to additional pages to display and modify related information such as Edit Client Info 513, Users authorized to access and modify information 514, Locations of display devices 515, identities of devices groups 516, and identities of individual devices 517.

FIG. 5b illustrates another management hub module web page for a particular display device according to one embodiment of the present invention. This web page 502 displays and permits a user to modify a particular device group for this client. This device group has a device group name 521 and a description 522.

FIG. 5c illustrates a management hub module web page displaying a plurality of display devices according to another embodiment of the present invention. This web page 503 provides a mechanism to allow end users select locations 531 where one or more display device computers are located. The end user selects one location and access additional pages to view and edit information related to the devices at a location.

FIG. 5d illustrates yet another management hub module web page for a particular display device according to yet another embodiment of the present invention. Once an end user selects a location, a web page 504 provides a plurality of fields 541 to define information related to the location. The end user may edit the information by entering data into these fields and submitting the data 542 to the server.

FIG. 5e illustrates another management hub module web page for a particular display device according to an example embodiment of the present invention. This final web page 505 displays the location data 551 that an end user has specified. The web page 505 also displays the identity of display devices found at this location 552. One or more devices may be located at any given location.

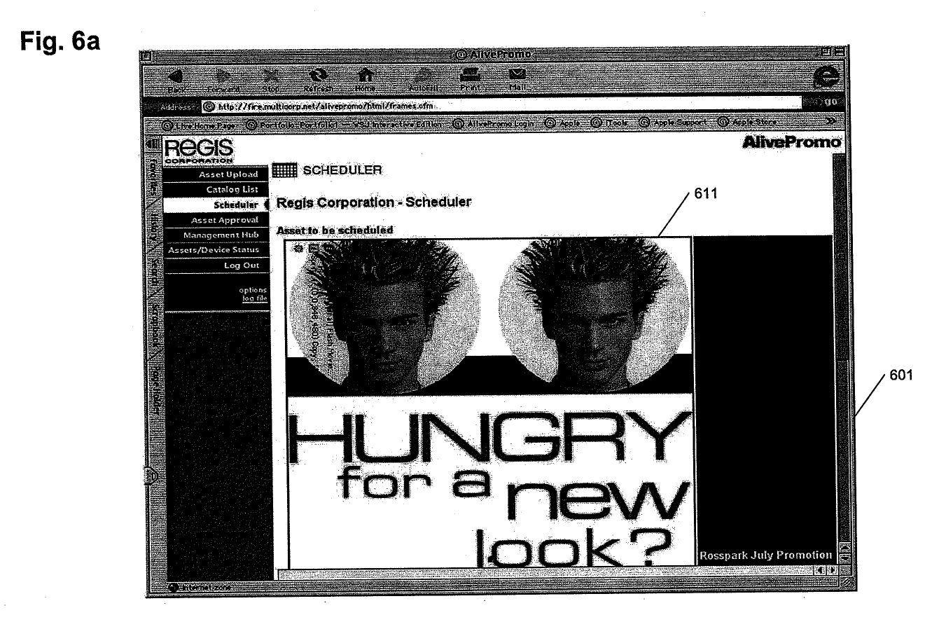

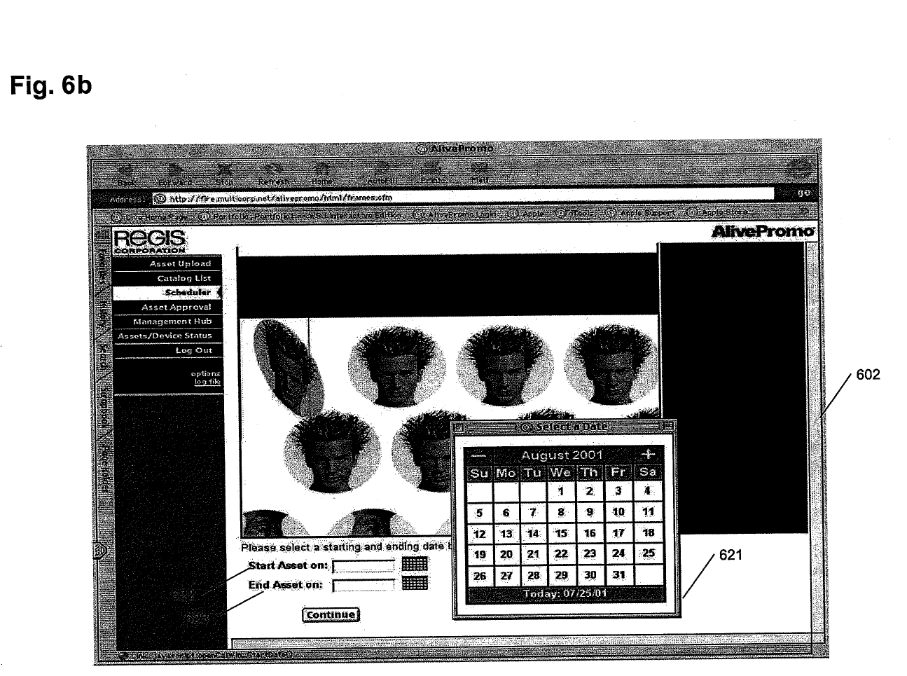

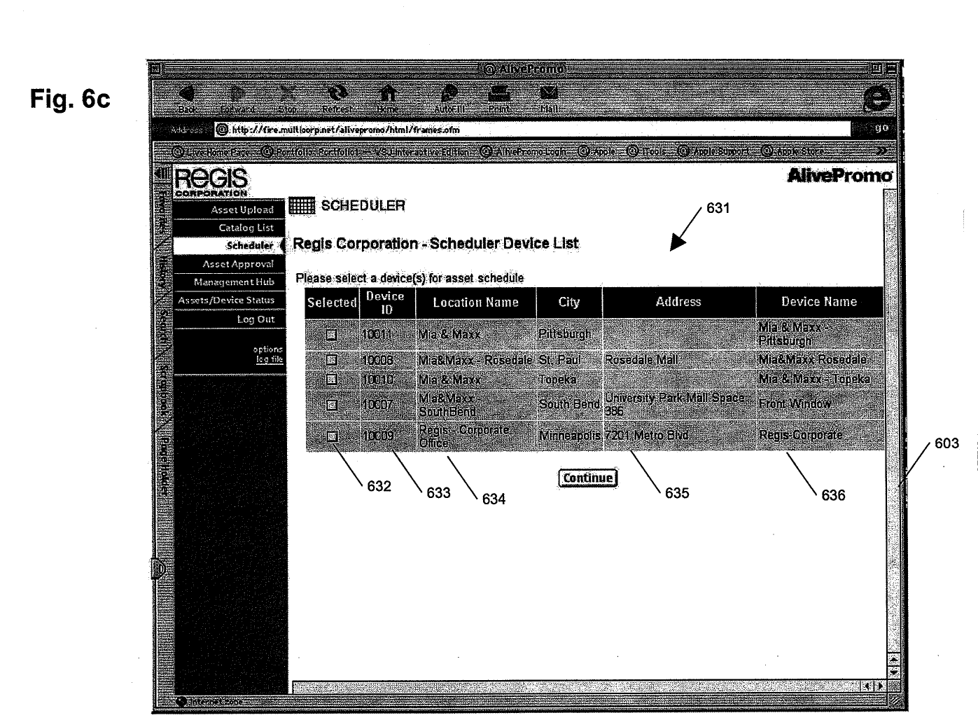

FIGS. 6a-6c illustrate a set of web pages used to schedule a set of display data onto a particular display computing system. FIG. 6a illustrates a scheduling module web page 601 for a particular display device according to an example embodiment of the present invention. This web page 601 shows a multimedia image 611 representing the display data to be output to a display device. In one embodiment, the image 611 is a FLASH video sequence that may be displayed within the web browser using a FLASH PLAYER plug-in. As such, the sequence of video images will be shown to the end user.

FIG. 6b illustrates another scheduling module web page for a particular display device according to an example embodiment of the present invention. This second web page 601 also shows the set of multimedia data 611 as well as a scheduling input window 621 that allows end users to specify both the starting date 622 and the end date 623 for this particular set of multimedia data 611.

FIG. 6c illustrates yet another scheduling module web page for a particular display device according to an example embodiment of the present invention. This final web page illustrates a list 631 of all devices for this client that may permit data to be scheduled. This list 631 allows a user to select one or more locations to have the set of multimedia data added to its schedule. The list also contains data to uniquely identify the display computing system 633, the display location 634, the display city and address 635, and a device name 636.

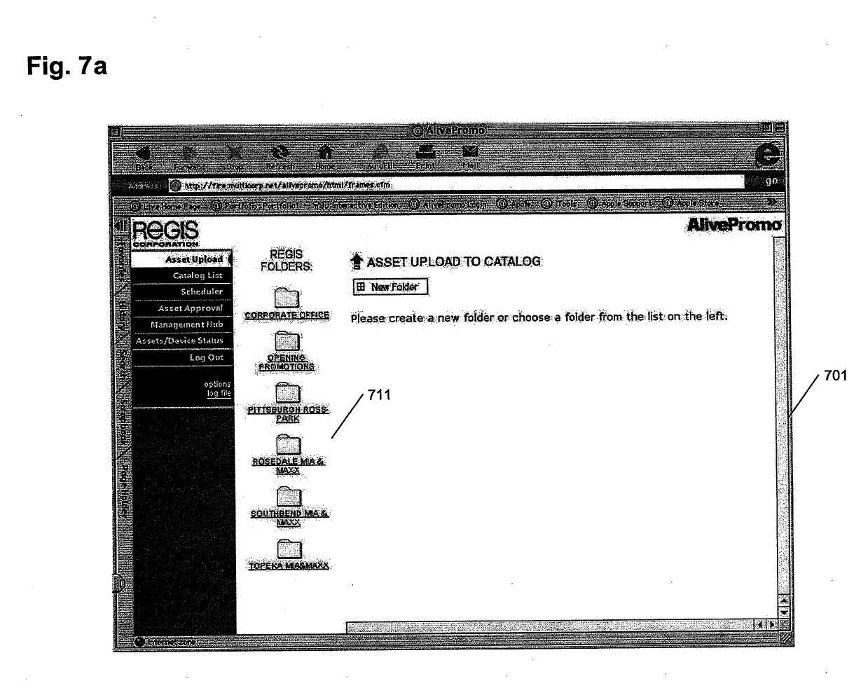

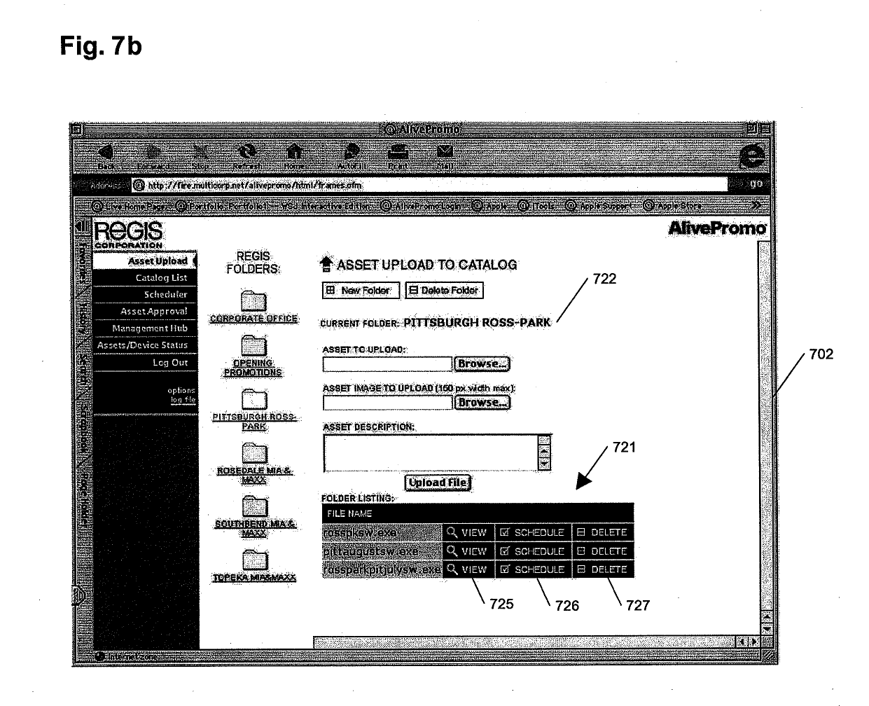

FIGS. 7a and 7b illustrate a set of web pages used to define the set of multimedia data to be uploaded to a display computing system. FIG. 7a illustrates an asset upload module web page 701 according to an example embodiment of the present invention. This page 701 contains a folder 711 for each display computing system for a given client. The end user selects the folder 711 corresponding to the display device that is to be specified.

FIG. 7b illustrates another asset upload module web page according to an example embodiment of the present invention. Once a folder 711 has been selected, the second web page 702 displays a page that identifies the sets of display data 721 that are part of the data uploaded to the display computing system identified for this folder 722. An end user may specify an additional set of data to be included in an upload using a set of fields 723 on the web page 702. The end user may view 725, edit a particular schedule 726, and delete 727 a particular set of multimedia data for this location as needed.

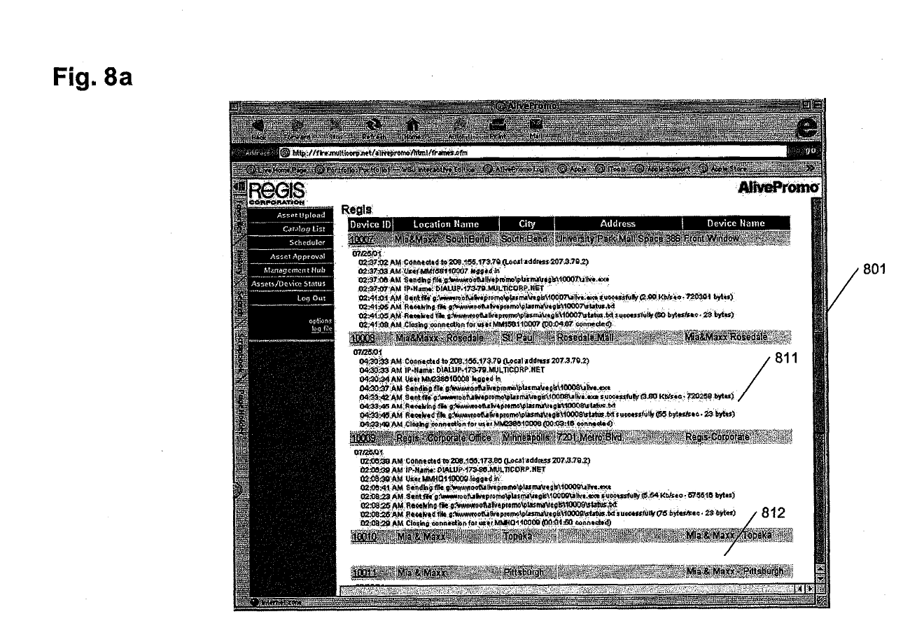

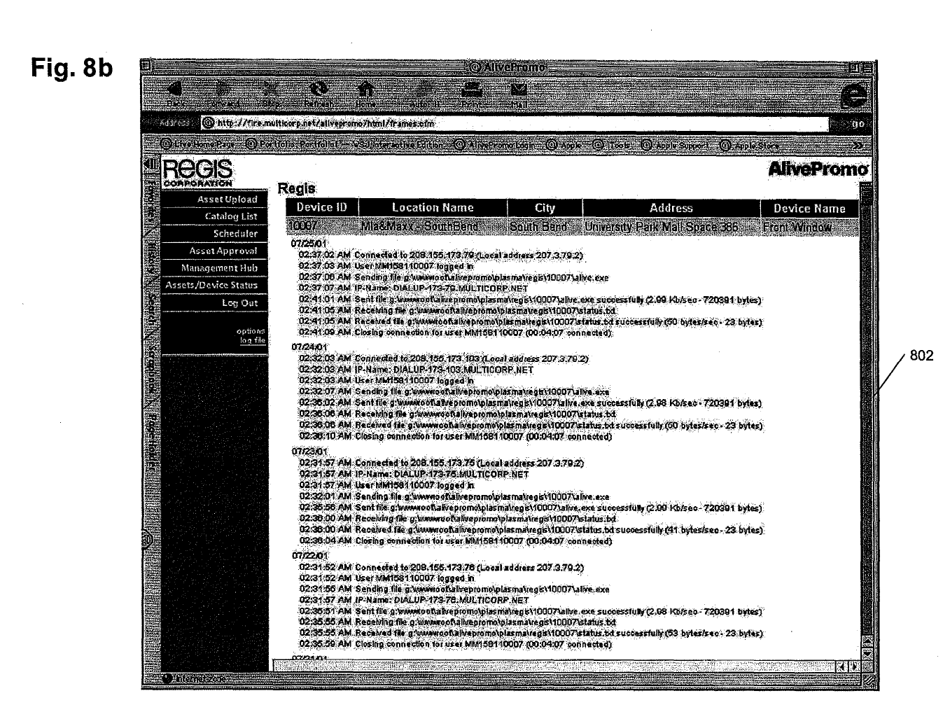

FIGS. 8a and 8b illustrate a pair of web pages that contains upload logging information. FIG. 8a illustrates an asset upload status info web page 801 that contains log information for a number of display computing systems all on the same date. Similarly, FIG. 8b illustrates another asset upload status info web page 802 that contains log information for a number of days of information for a single display computing system. For each contact between a display computing system 811, a plurality of entries illustrating the data transferred, its success status, and the time of the event are logged. If contact with a display computing system does not occur, no log entries are shown 812.

FIG. 1 illustrates an example of a suitable operating environment in which the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A processing devices attached to a communications network 100 typically includes at least some form of computer readable media. Computer readable media can be any available media that can be accessed by these devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by a programmable processing devices. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

While the above embodiments of the present invention describe a distributed processing and image display system for delivering promotional and advertisement related images to remote display devices, one skilled in the art will recognize that the use of a particular computing architecture for a display computing system and a web server are merely example embodiments of the present invention. It is to be understood that other embodiments may be utilized and operational changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. The present invention is presently embodied as a method, apparatus, and article of manufacture for providing a Transceiver System for High Speed Digital Signaling.

1. A system for displaying content information, the system comprising:
a server storing a communication schedule, a display schedule, and content information;
a remote display device communicatively coupled to the server, the remote display device being configured to store a copy of the communication schedule, the display schedule, and the content information, and to initiate communication with the server at communication times indicated in the copy of the communication schedule to download from the server an updated copy of the communication schedule, display schedule, and content information; and
a client device communicatively coupled to the server, the client device being configured to generate the display schedule and content information, and to store the display schedule and content information on the server;
whereby the client device enables a client to generate the display schedule and content information, and the display device displays the content information according to the display schedule, and the display device periodically initiates communication with the server according to the communication schedule.

2. The system according to claim 1, wherein the content and display schedule are stored in a database on the server.

3. The system according to claim 1, wherein the server further comprises:
a status logging module for maintaining status information regarding the remote display device, the status based at least in part on whether the remote display device initiates communication with the server according to the communication schedule, whereby service can be initiated on the remote display device if the remote display device did not initiate communication with the server.

4. The system of claim 3, wherein the server further comprises:
a maintenance interface module for obtaining approval of the content and the display prior to transmission to the remote display device.

5. The system according to claim 4, wherein the client communicates with the server over an Internet connection via a web browser to define the content and the display schedule for the remote display device.

6. The system according to claim 1, wherein the content comprises at least one type of content selected from the group consisting of: digital images, digital video, and audio information.

7. The system according to claim 1, wherein the display schedule comprises date and time information relating to when particular content is to be displayed by the remote display device.

8. The system according to claim 1, wherein the display schedule provides scheduling information for multiple sets of content to be displayed by the remote display device in a sequence.

9. The system according to claim 1, wherein the remote display device obtains a default set of display information to be output during times not corresponding to the display schedule received from the server.

10. The system according to claim 1, wherein the server includes an authentication module that determines if a user is permitted access, an asset status module that provides a user with access to identity and status of the content information and display schedule, an asset approved module that determines whether the content information and display schedule can be transmitted, and a management hub module that provides a user with access to identity and location of the remote display device.

11. A system for displaying content information, the system comprising:
a plurality of remote display devices, each remote display device being configured to display respective content in accordance with a corresponding display schedule, wherein the content displayed on one of the remote display devices can differ from the content displayed on each of the other display devices;
a server being communicatively coupled to each of the remote display devices, the server being configured to provide the respective content and the corresponding display schedule to each of the remote display devices when the remote display device initiates communication with the server in accordance with a communication schedule, the server also being configured to provide any updates to the communication schedule; and
whereby each remote display device displays the respective content according to the display schedule, and each display device periodically initiates communication with the remote server according to the communication schedule.

12. The system of claim 10, further comprising:
a plurality of client devices communicatively coupled to the server, each of the client devices being configured to provide the respective content for at least one of the remote display devices to the server.

13. The system of claim 11, wherein each client device is configured to store scheduling information in the corresponding display schedule for the provided content on the server.

14. The system of claim 11, wherein the server determines which remote display device will obtain which content based on information provided by the client device.

15. The system according to claim 11, wherein the server comprises:
an asset status module for maintaining status of each of the plurality of remote display devices based on whether each remote display device initiated communication with the server according to the communication schedule.

16. The system according to claim 11, wherein the server comprises:
an asset approval module configured to present respective content and the corresponding schedule for at least one remote display device to a user of one of the client devices for review and approval prior to providing the respective content and corresponding display schedule to the remote display device.

17. A method for electronically displaying advertising images on remote display devices, the method comprising:
allocating a time slot for each remote display device to call a display content server to obtain display content and schedule information from the display content server;
calling the display content server with each remote display device at the respective allocated time slot;
obtaining at each remote display device respective display content and schedule information from the display content server; and
displaying on each remote display device the respective display content in accordance with the schedule information.
